(19) United States
(12) Patent Application Publication
(10) Pub. No.: US 2017/0239599 A1
(43) Pub. Date: Aug. 24, 2017

(54) Filter Element for a Filter Device of an Internal Combustion Engine and a Filter Device for an Internal Combustion Engine

(71) Applicant: Daimler AG, Stuttgart (DE)

(72) Inventors: Philipp WEBER, Esslingen (DE); Uwe BINDEL, Weinstadt (DE); Eric SCHUMACHER, Bingen (DE); Joris DE JONG, Esslingen a.N. (DE); Ling DETTMANN, Schlaitdorf (DE); Reinhold BRUEHL, Weinstadt (DE); Wolfgang ENDERLE, Hochdorf (DE); Johannes GUETHOFF, Stuttgart (DE); Margarita PETROSSIANTS, Stuttgart (DE); Nikolaos SAVVANIS, Stuttgart (DE)

(73) Assignee: Daimler AG, Stuttgart (DE)

(21) Appl. No.: 15/519,404

(22) PCT Filed: Oct. 13, 2015
(86) PCT No.: PCT/EP2015/002015

§ 371 Date: Apr. 14, 2017

(30) Foreign Application Priority Data
Oct. 16, 2014 (DE) 10 2014 015 265.0

(51) Int. Cl. B01D 35/30; F01M 11/03; B01D 35/147

(52) U.S. Cl. CPC B01D 35/30; B01D 35/147; F01M 11/03; B01D 2201/304; F01M 2011/031

(57) ABSTRACT

A filter element for a filter device of an internal combustion engine, in particular a motor vehicle, is disclosed. The filter element for filtering a fluid of the internal combustion engine can be inserted in the direction of an insertion axis along a lateral wall of a filter housing. The filter element has at least one sealing element for fluidically blocking at least one throughflow opening formed in the lateral wall.

### BACKGROUND AND SUMMARY OF THE INVENTION

The invention relates to a filter element for a filter device of an internal combustion engine, and to a filter device for an internal combustion engine, in particular a motor vehicle.

Such a filter element for a filter device of an internal combustion engine, in particular of a motor vehicle, and such a filter device are already known from WO 2014/079591 A1. The filter device is, for example, a lubricant filter which is used for filtering a fluid in the form of a lubricant, in particular in the form of lubricating oil, of the internal combustion engine, wherein components of the internal combustion engine are lubricated and/or cooled down by means of the lubricant. In this case, the filter device comprises a filter housing, by means of which a receiving region is delimited. Furthermore, the filter device comprises a filter element, by means of which the fluid is filtered. Here, the fluid passes through the filter material. The filter material has pores of a certain size.

If particles are contained in the fluid which are larger than the pores, then the particles remain attached to the filter material, whereby the fluid is filtered by means of the filter element.

In this case, the filter element can be inserted into the receiving region in an insertion direction and can thereby be arranged at least partially in the receiving region. The filter element is thus inserted in the receiving region in the operational state of the filter device and is thus at least partially arranged therein.

During the operation of the internal combustion engine, particles from the fluid are increasingly added to the filter element, in particular the filter material. In order to avoid excessive flow resistance for the fluid caused by the filter element, the filter element must be replaced by a new filter element after a certain period of operation. To that end, the used filter element is removed from the receiving region or from the filter housing against the insertion direction and replaced by a new filter element. Replacing the filter element during servicing is also referred to as a filter change.

When the filter element is changed, it is advantageous to empty the receiving region or the filter housing before the filter element is removed, which is also referred to as draining the filter device. When the filter housing is emptied, the oil can either be drained into an oil pan, for example in the case of lorries, or the oil can be completely drained during servicing for an oil change, e.g., in the case of passenger vehicles.

In the case of the filter device described here, a large part of the oil which is still in the filter housing can be drained from the filter housing during or before the filter change through passage openings in the threaded section of the filter housing cover and a lateral channel-shaped housing passage by means of a special draining device. In the operating state, the draining device is closed by a closure element. The draining device and the closure element are arranged and configured in relation to the filter housing and to the oil pan in such a way that, during servicing, the oil present in the oil pan can also be drained off.

EP 1 094 203 B1 also shows an oil filter device having a lateral housing passage in the oil filter housing, through which the oil still located in the filter housing is drained into the oil pan during servicing. The sealing of the passage for the operating state is ensured by a filter housing cover with which the filter housing can be closed. For this purpose, the cup-shaped filter housing cover has an annular seal on its free end which, in the closed position, forms a drain barrier opposite the downstream passage.

The object of the present invention to further develop a filter element and a filter device of the type mentioned above which ensure a reliable operation and enable an advantageous implementation of a filter change.

In order to further develop a filter element in such a way that a particularly reliable operation of the filter device or an advantageous implementation of a filter change can be ensured, it is provided according to the invention that the filter element has at least one sealing element for the fluidic blocking of at least one throughflow opening formed in a lateral wall of the filter housing. The filter element can be inserted in the direction of an insertion axis along the lateral wall into a receiving region of the filter housing. The receiving region is externally delimited by the lateral wall. This wall has at least one throughflow opening which can be flowed through by the fluid which is received in the receiving region. In the operating state, the at least one throughflow opening is sealed by the sealing element.

When the filter element is changed, the throughflow opening is unblocked when the filter element is removed and the fluid located in the receiving region can be discharged or drained through the at least one throughflow opening either from the receiving region towards an oil pan or the fluid can flow in reverse—in the case of filter devices in which, during servicing, all of the remaining fluid is to be drained from the receiving region via a drain valve in the filter housing cover via a geodetically lowest point—from a reservoir into the receiving region of the filter.

If the receiving region or the lateral wall of the filter housing is, for example, cylindrically shaped, then the at least one throughflow opening is arranged in the radial direction relative to the insertion axis in the lateral wall of the receiving region; it is thus a radial throughflow opening in contrast to a possible drain valve which is usually formed in a wall, for example in the filter housing cover, which delimits the receiving region in the axial direction.

In the operational state of the filter device, the at least one radial throughflow opening is fluidically blocked by means of the sealing element so that, in a state in which the filter element is correctly arranged in the receiving region, the fluid located in the receiving region is not able to escape undesirably from the receiving region via the throughflow opening or the throughflow openings. By providing the filter element with a sealing element for fluidically blocking the throughflow opening, a continuously effective seal is ensured even in the case of a long service life of the filter. The seals can be replaced in the course of the filter change so that signs of fatigue such as, for example, in filter housing-side seals, are not expected. During servicing, the at least one passage opening is simply unblocked by a corresponding offset of the filter against the insertion direction. As a result, the filter change can be implemented particularly advantageously: no further device has to be operated in the event of the fluid draining from the receiving region into an oil pan.

Furthermore, by the sealing element being formed for fluidically blocking the at least one throughflow opening, an advantageous and, for example, at least substantially piston-shaped geometry of the sealing element can be achieved, with which a particularly high robustness of the sealing element is associated. For example, the filter element as a whole can have a cylindrical shape or the shape of an at least substantially straight circular cylinder such that a substantially higher robustness of the sealing element can be achieved compared to a commonly provided plug-shaped extension. The sealing element of the filter element according to the invention is thus resistant to damage. Furthermore, the sealing element can be used for centering the filter element or at least for supporting the centering of the filter element in the filter housing so that a particularly advantageous and simple and thus time-saving and cost-effective replacement of the filter element can be carried out.

The filter element has a filter material, through which the fluid can flow, for filtering the fluid. The filter material has pores, for example, through which the fluid can flow. If particles are contained in the fluid which are larger than the pores, then the particles cannot flow through the pores, but rather the particles remain on the filter material, whereby the particles are filtered from the fluid.

The fluid is a lubricant, such as, for example, lubricating oil, which is also referred to as oil. Such a lubricant is used, for example, for cooling down and/or lubricating components of the internal combustion engine. If the fluid is a lubricant, then the filter device is formed as a lubricant filter. However, the preceding and following statements may also be applied to other filter devices or to other fluids.

The filter material is arranged around a support structure such that the largest possible material surface is steadily available for filtering. In an advantageous embodiment, the sealing element is arranged radially with respect to the insertion axis around the support structure with the same or greater spacing than the filter material. In this way, the sealing element ends with the filter material on the outside circumference or it extends outwards over the filter material.

The radial arrangement is therefore not to be understood as being restricted to circular filter cross sections. The term “radial” is to be understood as “perpendicular to the insertion axis”, with the additional aspect that the sealing element surrounds the filter material or goes around the filter material. By arrangement with the same spacing, it is to be understood, for example, that the sealing element and the filter material are arranged with a common outer diameter or outer circumference. If, for example, the sealing element protrudes outwards beyond the filter material, then the sealing element is arranged with a larger outer diameter or outer circumference than the filter material. As a result, the centering of the filter element during its arrangement in the receiving region can be supported particularly well by the sealing element such that a particularly simple filter change can be carried out.

A further embodiment is characterised in that the sealing element surrounds at least a partial region of the filter material on the outer circumference side. Thus, at least a partial region of the filter material is covered by the sealing element in a direction which runs perpendicularly to the insertion direction, viewed from the outside. In this way, for example, an extension, in particular length, of the filter element running in the insertion direction can be kept small or the available filter surface can be maximized such that the installation space available is optimally exploited. Furthermore, a particularly advantageous change of the filter element can be carried out by this embodiment because the filter element can be positioned particularly well in relation to the filter housing via the sealing element.

In order to make the mounting of the filter element particularly easy to handle, a further embodiment of the invention provides that the support structure is formed at a distance from the insertion axis and along a direction of longitudinal extension of the filter which coincides with the direction of the insertion axis. During mounting, the support structure, which is arranged along the direction of longitudinal extension of the filter and which is formed at a distance from the insertion axis, can thus simply be placed on a support dome in the receiving region of the filter housing, whereby the movement of the filter during insertion or removal is guided. Thus, the insertion direction is clearly defined by the direction of longitudinal extension or by the support structure of the filter element such that the filter element can be mounted or exchanged in a particularly simple manner.

In a further embodiment of the invention, the sealing element comprises at least two sealing parts, which are spaced from one another, in particular in the insertion direction, and can be supported on the lateral wall for sealing the throughflow opening. As a result, a particularly advantageous sealing effect of the sealing element is achieved by the throughflow opening being blocked fluidically securely above and below its boundary when the filter element is installed. In addition, the filter element can be mounted particularly easily and therefore changed, since the risk of tilting the filter element can be kept low by using sealing parts which are spaced apart from one another.

The sealing parts are preferably attached to a sealing wall which is impermeable for the fluid and which additionally stabilizes the filter element. The sealing wall therefore supports easy handling of the filter element when it is changed.

Finally, it has been found to be advantageous if the sealing parts are softer than the sealing wall in order to achieve a particularly advantageous sealing effect. Furthermore, the filter element can thereby be arranged particularly well in the receiving region.

In order to further develop a filter device in such a way that a particularly reliable operation of the filter device or an advantageous implementation of a filter change can be ensured, it is provided according to the invention that the filter element has at least one sealing element for fluidly blocking at least one throughflow opening formed in a lateral wall of the filter housing. The filter element can be inserted in the direction of an insertion axis along the lateral wall into a receiving region of the filter housing. The receiving region is externally delimited by the lateral wall. This wall has at least one throughflow opening which can be flowed through by the fluid which is received in the receiving region. In the operating state, the at least one throughflow opening is sealed by the sealing element.

Advantageous embodiments of the filter element according to the invention are seen as advantageous embodiments of the filter device according to the invention and vice versa.

It has thus been shown to be particularly advantageous when the filter element of the filter device according to the invention is a filter element according to the invention.

Further advantages, features and details of the invention arise from the following description of preferred exemplary embodiments as well as by means of the drawings. The features and feature combinations cited above in the description and the features and feature combinations cited below in the description of the figures and/or shown in the figures alone can be used not only in each specified combination but also in other combinations or individually without exceeding the scope of the invention.

### BRIEF DESCRIPTION OF THE DRAWINGS

FIG. 1 is a schematic perspective view of a filter element for a filter device according to a first embodiment of an internal combustion engine, in particular of a motor vehicle, wherein the filter element for filtering a fluid of the internal combustion engine can be inserted in an insertion direction into a receiving region which is delimited by a filter housing of the filter device and can thus be arranged at least partially in the receiving region and has a sealing element for the fluidic of throughflow openings in the lateral wall of the filter housing;

FIG. 2 is a schematic and partially sectional perspective view of the filter element according to FIG. 1;

FIG. 3 is a schematic perspective view of the filter housing of a filter device according to the first embodiment;

FIG. 4 is a schematic longitudinal sectional view of the filter housing according to FIG. 3;

FIG. 5 is a schematic and partially sectional side view of the filter device according to the first embodiment;

FIG. 6 is a further schematic and partially sectional side view of the filter device according to FIG. 5;

FIG. 7 is a schematic and perspective sectional view of a lubricating oil supply device for an internal combustion engine according to a second embodiment;

FIG. 8 is a schematic perspective view of the filter element of the filter device according to the second embodiment;

FIG. 9 is a schematic and partially sectional perspective view of the filter element according to FIG. 8;

FIG. 10 is a schematic and partially sectional perspective view of a filter housing cover corresponding to the filter housing of the filter device according to the second embodiment;

FIG. 11 is a schematic and perspective sectional view of the lubricating oil supply device according to the second embodiment;

FIG. 12 is a further schematic and perspective sectional view of the lubricating oil supply device according to the second embodiment;

FIG. 13 is a further schematic and perspective sectional view of the lubricating oil supply device according to the second embodiment;

FIG. 14 is a schematic and perspective side view of the lubricating oil supply device according to a further embodiment;

FIG. 15 is a schematic perspective view of the filter element of the lubricating oil supply device according to FIG. 14;

FIG. 16 is a schematic and perspective top view of the cover of the lubricating oil supply device according to the further embodiment;

FIG. 17 is a schematic and partially sectional perspective view of the cover according to FIG. 16;

FIG. 18 is a schematic and perspective sectional view of the lubricating oil supply device according to the further embodiment;

FIG. 19 is a further schematic and perspective sectional view of the lubricating oil supply device according to the further embodiment;

FIG. 20 is a further schematic and perspective sectional view of the lubricating oil supply device according to the further embodiment; and

FIG. 21 is a further schematic and perspective sectional view of the lubricating oil supply device according to the further embodiment.

### DETAILED DESCRIPTION OF THE DRAWINGS

In the figures, the same or functionally identical elements are provided with the same reference numerals.

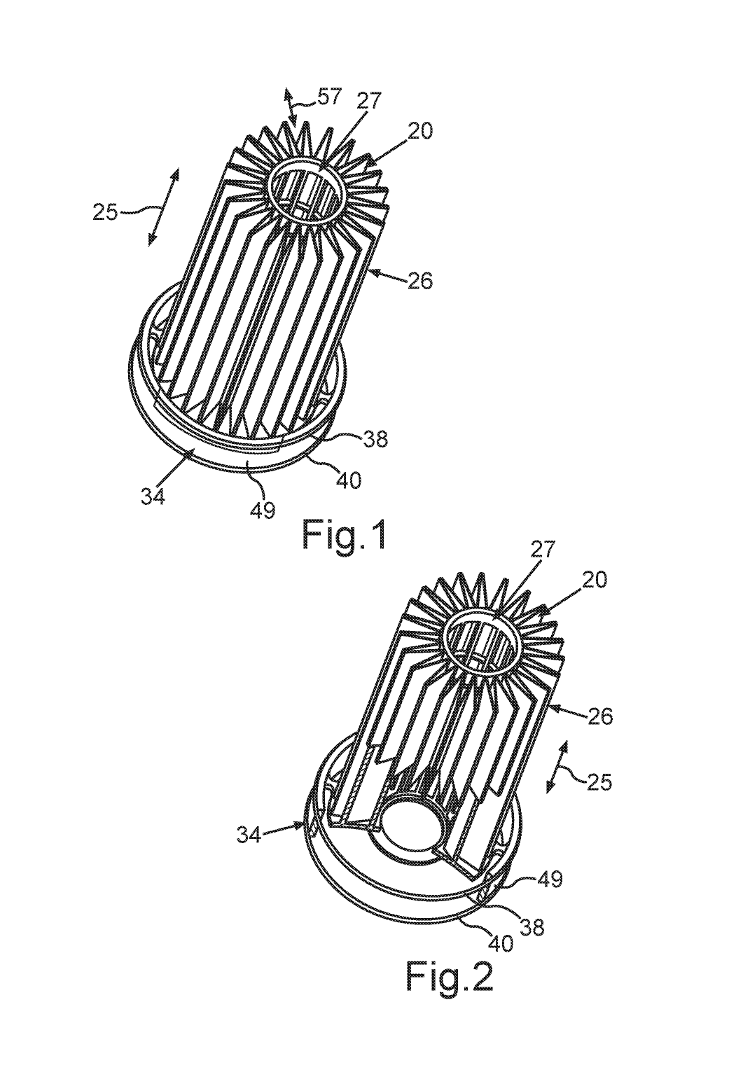

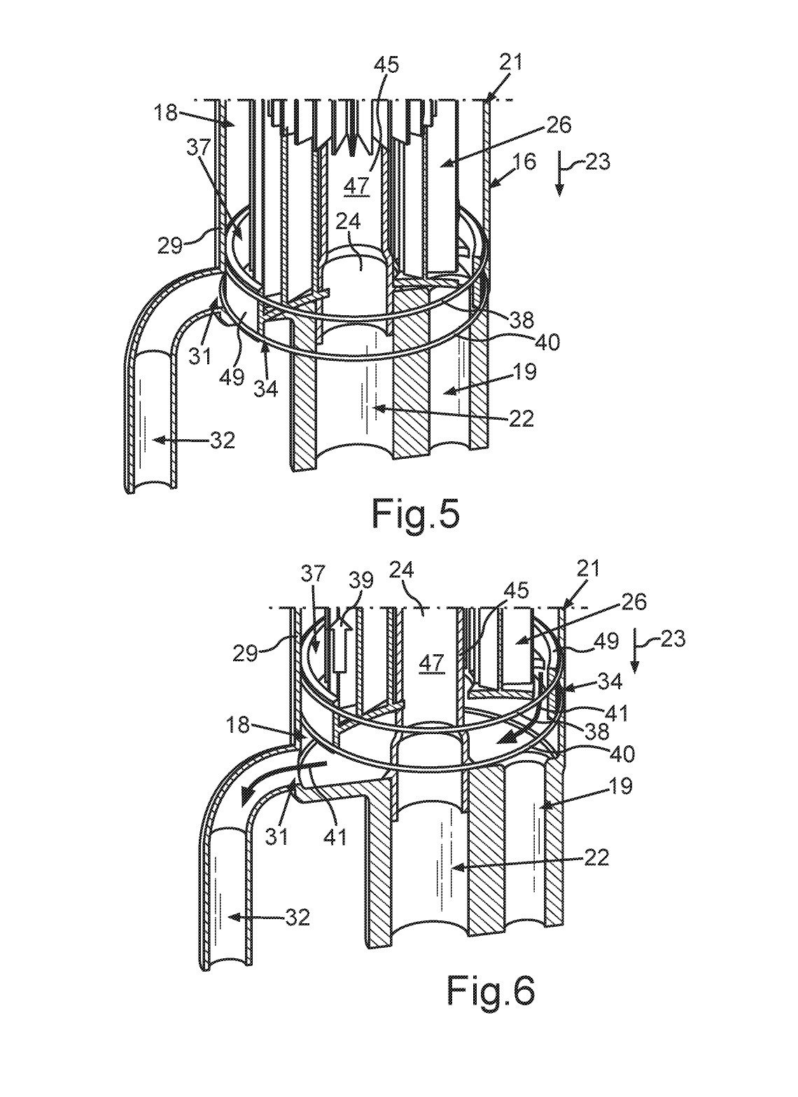

FIG. 1 is a schematic perspective view of a filter element, referred to as a whole by 20, for a filter device of an internal combustion engine of a motor vehicle shown in FIGS. 5 and 6 according to a first embodiment and referred to as a whole by 21. A fluid of the internal combustion engine is filtered by the filter device 21. In the present case, this fluid is a lubricant which is also referred to as lubricating oil or oil. Components of the internal combustion engine are lubricated and/or cooled down by means of the oil. The filter device 21 is thus a lubricant filter which is also referred to as an oil filter. Particles contained in the lubricant are filtered out of the lubricant by means of the oil filter.

The filter element 20 comprises a filter material 26 for filtering the fluid which is formed, for example, as a fleece or filter fleece. The filter material 26 can be flowed through by the fluid (lubricant), whereby particles are filtered out of the lubricant. Furthermore, the filter element 20 comprises an inherently rigid support structure 27, for example made of plastic, on which the filter material 26 is held.

It can be seen from FIGS. 1 and 2 that the sealing element 34 has at least two sealing parts 38 and 40 which are spaced apart from one another in the insertion direction or in the axial direction and which are formed, for example, as sealing rings, in particular O-rings. In this case, the sealing parts 38 and 40 are formed from an elastic material, in particular rubber, and ensure an appropriate and particularly effective sealing or fluidic blocking of the throughflow opening 31.

Furthermore, the sealing element 34 has a sealing wall 49 which is sealed against the lubricant and on which the sealing parts 38 and 40, which are formed separately from the sealing wall 49, are held. The sealing wall 49 is connected to the support structure 27 and, for example, is formed as one piece with the support structure 27. The sealing wall 49 and the support structure 27 can be made of a plastic, wherein the sealing wall 49 is inherently rigid and substantially more rigid than the sealing parts 38 and 40. In other words, the sealing parts 38 and 40 are softer than the sealing wall 49 such that a reliable seal is ensured. The sealing wall 49 is sealed against the lubricant such that it cannot flow through the sealing wall 49.

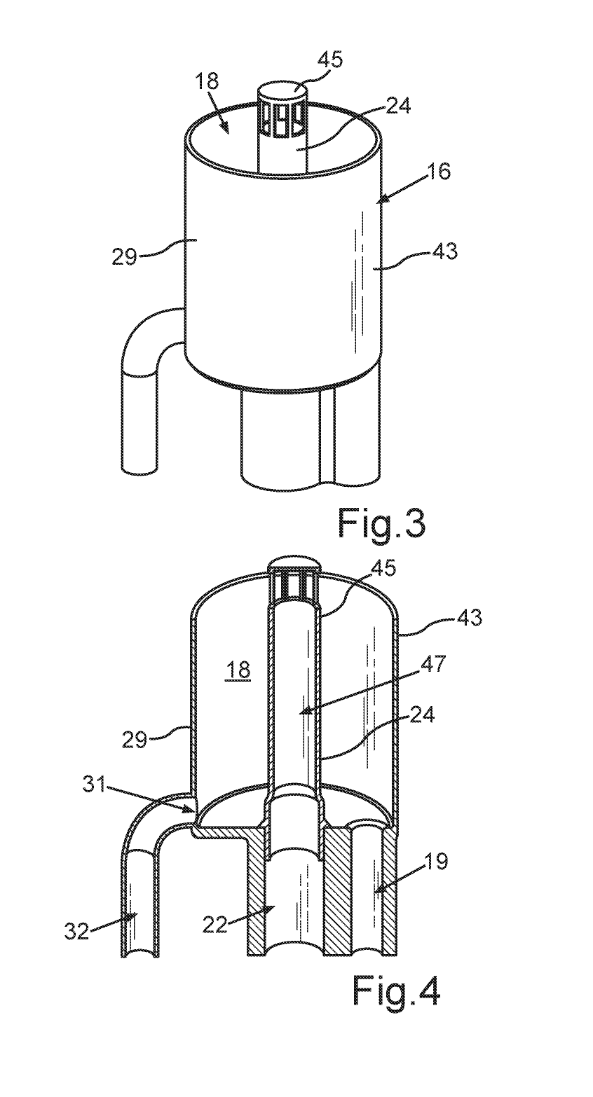

FIGS. 3 and 4 show the filter housing 16 which, for example, has a first housing part 43, which forms the lateral wall 29, as well as a second housing part 45. The housing part 43 and/or the housing part 45 are formed, for example, from a plastic and/or are formed intrinsically as one piece. Here, it is conceivable for the housing parts 43 and 45 to be formed as one piece with each other. In the present case, the housing parts 43 and 45 are separately formed components which are connected to each other. A support tube 24 is formed by the housing part 45, by means of which a further drain channel 47, which is fluidically connected to a drain channel 22, is delimited. The drain channels 22 and 47 thus form an overall drain channel.

During the mounting of the filter element 20, this is pushed onto the support tube 24, which is also referred to as a support dome, such that the support tube 24 is at least partially arranged in the filter element 20, in particular within the support structure 27. As a result, the filter element 20 is centered and held in position by means of the support tube 24, in particular via the support structure 27.

When viewing FIGS. 5 and 6 together, it is clear that the filter device 21 comprises a filter housing 16, by means of which a receiving region 18 is formed or delimited. The filter housing 16 can, for example, be made of plastic and/or as one piece. In the operational state of the filter device 21, the filter element 20 is arranged at least partially in the receiving region 18. For this purpose, the filter element 20 can be inserted into the receiving region 18 and thus into the filter housing 16 in the direction of an insertion axis, in short insertion direction. The insertion direction is illustrated in FIG. 5 by a directional arrow 23. It can be seen from FIGS. 1 and 2 that the filter element 20 has a direction of longitudinal extension which is illustrated by a double arrow 25, wherein the insertion direction coincides with the direction of longitudinal extension of the filter element 20. The receiving region 18 and the filter element 20 have an at least substantially cylindrical shape or the shape of an at least substantially straight circular cylinder such that the direction of longitudinal extension coincides with the axial direction of the filter element 20 and thus of the receiving region 18. A direction running perpendicularly to the axial direction, and thus also perpendicularly to the insertion axis, coincides with the radial direction of the receiving region 18 or of the filter element 20, wherein this radial direction is illustrated by a double arrow 57 in FIG. 1. In this case, the lubricant can flow through the filter material 26, for example, in the radial direction.

During the operating period, particles which are filtered out of the lubricant by means of the filter material 26 are gradually added to the filter material 26 and thus the filter element 20. In order to avoid excessive flow resistance for the lubricant caused by the filter element 20, the filter element 20 must be removed from the receiving region 18 after a certain operating period, for example, and replaced with an unused filter element. This replacement of the filter element 20 is also referred to as a filter change.

In order to be able to carry out the filter change as cleanly as possible, the lubricant should be removed as completely as possible from the filter or from the receiving region before the removal of the filter element 20. For this purpose, a throughflow opening 31, which can be flowed through by the lubricant, is formed in the lateral wall 29 of the receiving region 18 of the filter housing 16. The throughflow opening 31 in the embodiment of the filter housing 16 shown in FIG. 3 to 6 is a drain opening or discharge opening, via which lubricant which is located in the receiving region 18 can be discharged when the filter element 20 is removed, which occurs upwards in this case. The lubricant located in the receiving region 18 then initially flows in the radial direction out of the receiving region 18, for example, into an oil pan.

Furthermore, the filter element 20 has a sealing element 34 for fluidly blocking the throughflow opening 31. If the filter element 20 is arranged ready for operation in the receiving region 18, then the radially arranged throughflow opening 31 is fluidically blocked by means of the radially formed sealing element 34 and is thus sealed so that the lubricant located in the receiving region 18 does not undesirably flow out of the receiving region 18 of the filter housing 16 via the throughflow opening 31.

It can be seen from FIG. 5 that the sealing element 34 is arranged at a distance from the filter material 26 in the radial direction, i.e., in the direction running perpendicularly to the insertion direction. In other words, the sealing element 34 has a larger outer circumference or outer diameter than the filter material 26. In this case, a partial region of the filter material 26, when viewed in longitudinal extension, is completely surrounded by the sealing element 34 in the circumferential direction. This means that the designated longitudinal region of the filter material 26 is covered by the sealing element 34 in the radial direction, when viewed from the outside. It can also be seen from FIG. 5 that a receiving space 37 is formed by the sealing element 34, into which filter material 26 extends. As a result, for example, the axial length of the filter element 20 can be exploited well.

Furthermore, it can be seen from FIG. 5 that the sealing parts 38 and 40, which are held on the sealing wall 49 and thus supported on the sealing wall 49 on one side are supported on the radial wall 29 on the other side when the filter element 20 is arranged in the receiving region 18. The sealing part 38 is located above the throughflow opening 31 and the sealing part 40 is located below the throughflow opening 31 and thus seals the discharge opening.

FIG. 5 also shows that a passage channel 32 is connected to the throughflow opening 31, in which passage channel 32 the lubricant flowing through the throughflow opening 31 can flow out of the receiving region 18. As a result, the oil flowing out of the receiving region 18 via the throughflow opening 31 is discharged by means of the passage channel 32.

FIG. 6 shows the filter element during the removal of the filter element 20 from the receiving region 18 in a so-called servicing position, in which the filter element 20 unblocks the throughflow opening 31. As a result, the remaining fluid or oil located in the receiving region 18 can flow out of the receiving region 18.

During a filter change, the filter element 20 is moved out of the receiving region 18 and thus out of the filter housing 16, as is illustrated by the directional arrow 39, along the insertion axis and against the insertion direction. As a result, the sealing element 34 unblocks the throughflow opening 31 such that the lubricant can flow out from the receiving region 18 through the throughflow opening 31 and the passage channel 32, as illustrated by directional arrows 41 in FIG. 6. In order to ensure as complete draining as possible of the lubricant from the filter housing into an oil pan which is not shown, the throughflow opening is provided as far down as possible in the receiving region. Accordingly, the sealing member 34 is attached to the filter device 21 according to FIG. 1 to 6 at an axial end of the direction of longitudinal extension of the filter element 20.

The filter device 21 according to the first embodiment is used, for example, in a lubricant supply device for a lorry.

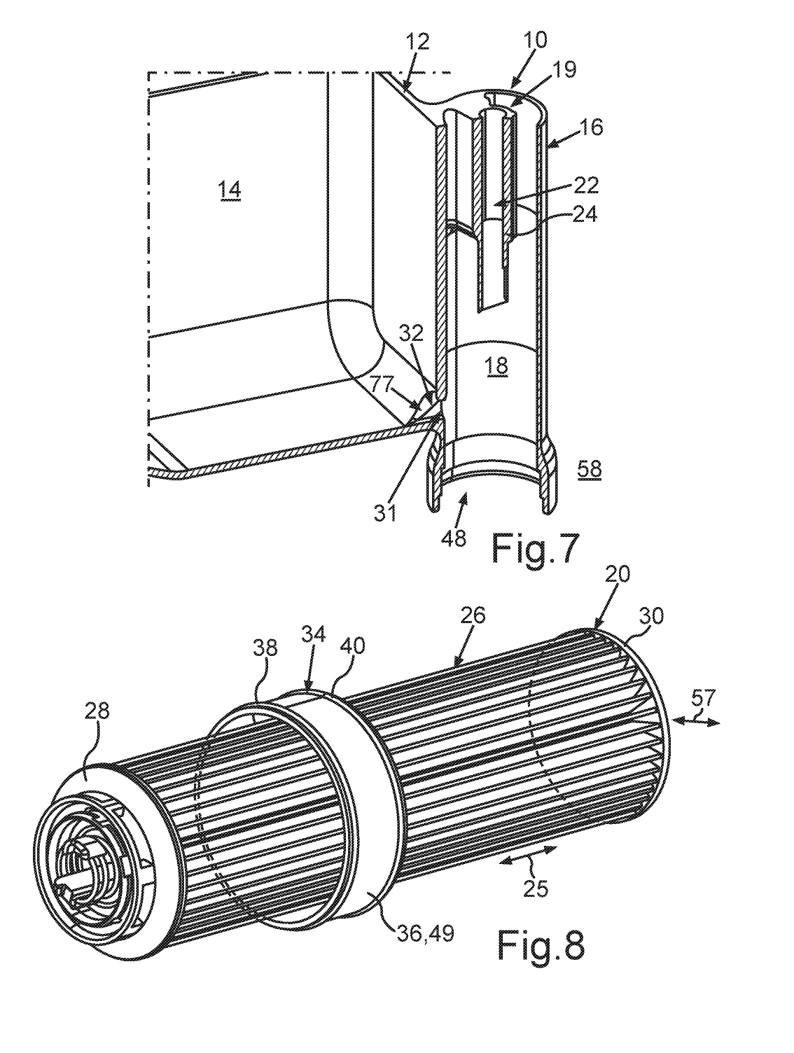

FIG. 7 to 13 relate to a lubricant supply device, as is used, for example, in passenger cars, and to a filter device 21 according to a second embodiment. In passenger cars, lubricant supply devices are usually provided, in which the lubricant or the oil is completely drained during servicing in order to carry out an oil change, for example. In the operating state, the lubricant is prevented from flowing out of a lubricant reservoir 14 in the direction of the filter housing 16 by the sealing element 34 attached to the filter element 20; the lubricant provided for filtering passes via another channel into the filter housing 16. In addition to the lubricant present in the receiving region 18 of the filter housing 16, the lubricant present in the lubricant reservoir 14 is also drained via the throughflow opening 31 from the receiving region 18 during servicing when a filter element 20 is changed. Therefore, the throughflow opening 31 is also referred to as a servicing opening or drainage opening.

The filter element 20 belonging to the second embodiment of the filter device 21 does not differ structurally from the filter element which belongs to the first embodiment of the filter device described above. In this regard, the previously described features also apply to the filter element shown in FIGS. 8, 9, 11, 12 and 13. Conversely, the further embodiments for these figures apply to the filter element shown in the first embodiment of the filter device. Only the assembly of the sealing element 34 is not necessarily arranged at an axial end of the filter element 20 for the embodiment of the filter device 21 being discussed here.

Depending on the height of the filter housing 16 at which the throughflow opening 31 to be blocked or closed is arranged, the sealing element 34 is arranged at different heights with respect to the longitudinal extension of the filter element 20. The height at which the sealing element 34 is in relation to the longitudinal extension is due to the relative position of the filter housing 16 with respect to the lubricant reservoir 14 or to the position of the passage channel 32 at the lowest point of the lubricant reservoir 14.

According to FIG. 7 to 13, the sealing element 34 is attached at least substantially in the center of the filter element 20.

FIG. 7 is a schematic and perspective sectional view of a lubricating oil supply device, which is referred to as a whole by 10, according to a second embodiment for an internal combustion engine of a motor vehicle, in particular of a passenger vehicle. An oil pan 12, by means of which a lubricating oil reservoir 14 is delimited, can be seen in FIG. 7 from the lubricating oil supply device 10. This means that the lubricating oil can be received and stored in the reservoir 14 and thus in the oil pan 12.

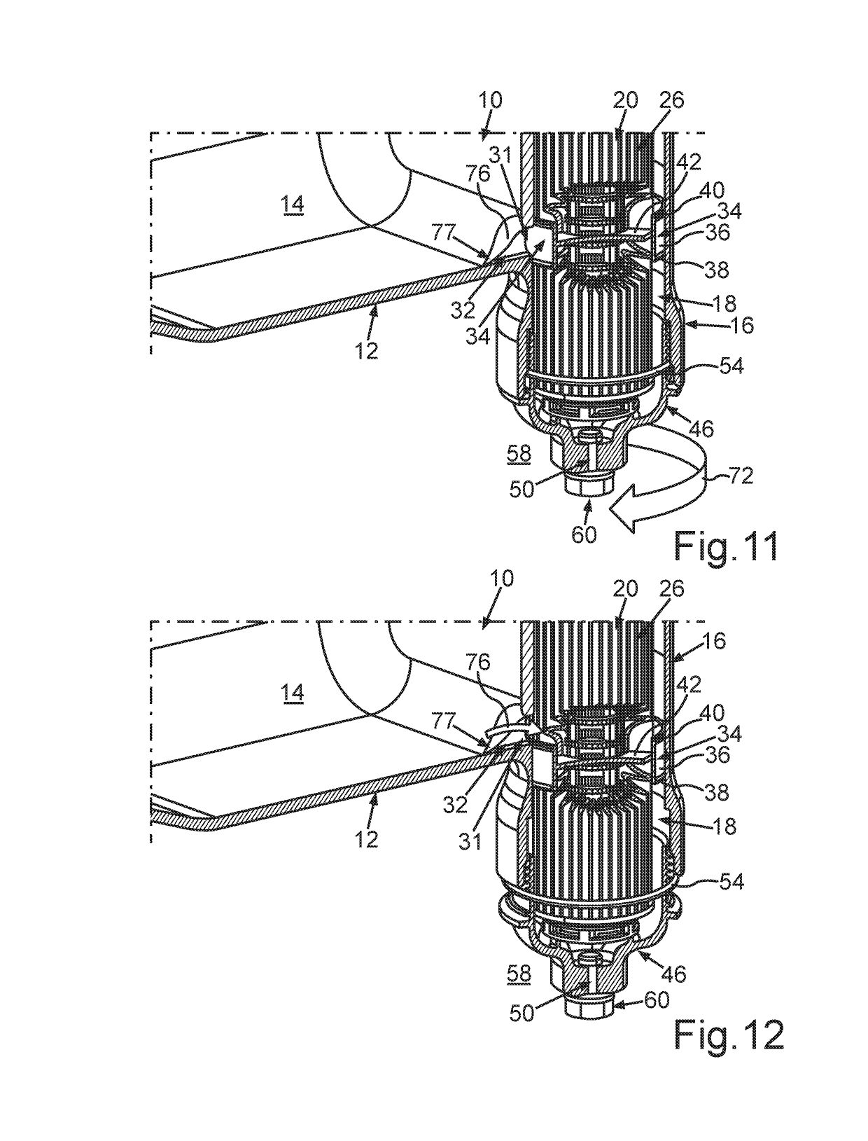

FIG. 7 furthermore shows the filter housing 16 of the lubricating oil supply device 10, wherein a receiving region for accommodating the filter 20 is delimited by the filter housing 16. FIG. 7 shows that the filter housing 16 is formed as one piece with the oil pan 12. FIG. 8 is a schematic perspective view of the filter element, referred to as a whole by 20, which is also referred to as a filter insert, oil filter or oil filter insert. When seen together with FIG. 11, it is clear that the filter insert can be arranged or, in the operational state of the lubricating oil supply device 10, is arranged at least partially in the receiving region 18. In the present case, the filter insert is at least predominantly, in particular completely, arranged in the receiving region 18.

The lubricating oil supply device 10 comprises, for example, a conveying element (not shown in FIG. 7) in the form of a pump, by means of which the lubricating oil is conveyed from the oil pan 12 to the components to be lubricated. FIG. 7 shows an inflow channel 19, by means of which the lubricating oil is guided into the receiving region 18 by the pump functioning as an oil pump. The lubricating oil can flow from the receiving region 18 through the filter element 20 and then flow filtered to the drain channel 22 to the lubrication points of the internal combustion engine to be supplied with the lubricating oil. The drain channel 22 is delimited by the support tube 24 of the filter housing 16, wherein the filter insert 20 is attached to the support tube 24 in its state arranged in the receiving region 18. This means that the support tube 24 and thus the drain channel 22 are at least partially arranged in the filter insert.

The filter insert comprises the filter material 26 for filtering the lubricating oil, said filter material 26 being formed, for example, from fleece. Furthermore, the filter insert comprises two inherently rigid cover discs 28 and 30, on which the filter material 26 is held.

The lubricating oil supply device 10 also comprises the passage channel 32, which is also referred to as a bypass or bypass channel. It is particularly clear from FIG. 7 that the passage channel 32 opens at one end to the lubricant reservoir 14 of the oil pan 12 and at the other end into the receiving region 18 of the filter housing 16.

It can be seen from FIG. 8 that the filter insert has the sealing element 34 for fluidically blocking the throughflow opening 31 and thus the passage channel 32. The sealing element 34 is also referred to as sealing geometry and comprises a first sealing part in the form of a ring 36 which is inherently rigid, for example. The ring 36 or the sealing element 34 is connected to the cover discs 28 and 30 via the support structure 27, which is not visible in this image, and is arranged between them in the direction of longitudinal extension of the filter insert. In the present case, the sealing wall 49 is formed by the ring 36. The sealing element 34 comprises the further sealing parts 38 and 40 which are designed, for example, as O-rings. In this case, the sealing parts 38 and 40 are formed from an elastic material, in particular rubber, and ensure an appropriate and particularly effective sealing or fluidic blocking of the passage channel 32. The passage channel 32 corresponds to the throughflow opening 31.

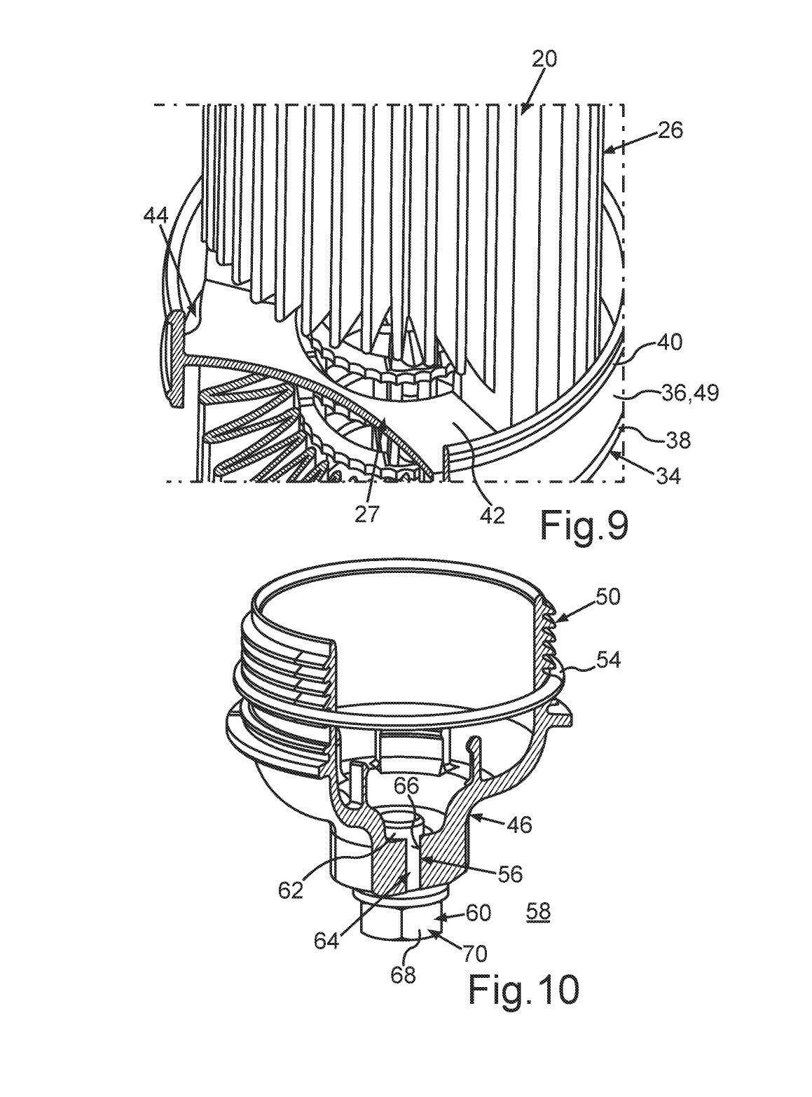

FIG. 9 shows the filter insert in an enlarged view. It can be seen from FIG. 9 that the ring 36 is connected to the cover discs 28 and 30 via a perforated disk 42 by means of the support structure 27. The sealing element 34, in particular the disc 42, has at least one clearance in the form of a passage opening 44 through which the lubricating oil can flow.

FIG. 10 is a schematic and partially sectional perspective view of a filter housing cover 46 of the lubricating oil supply device 10. When seen together with FIG. 7, it is clear that the filter housing 16 has a mounting opening 48 which is formed as a passage opening. The filter insert (filter element 20) can be introduced along its direction of longitudinal extension into the filter housing 16 or the second receiving region 18 via the mounting opening 48. The mounting opening 48 and thus the receiving region 18 can be closed by means of the cover 46. The closed state of the mounting opening 48 can be seen in FIG. 11, wherein the filter housing cover 46 is reversibly detachably connected to the filter housing 16. For this purpose, the cover 46 has a first thread in the form of an external thread 50 which can be seen in FIG. 10. The filter housing 16 has a second thread in the form of an internal thread 52 corresponding to the external thread 50. The cover 46 can be screwed to the filter housing 16 in this way.

As a result, the cover 46 is held reversibly detachably on the filter housing 16.

A sealing element 54 is held on the cover 46, said sealing element 54 being formed, for example, as an O-ring, and sealing the receiving region 18 against the outside or the environment 58 in the mounted state of the cover.

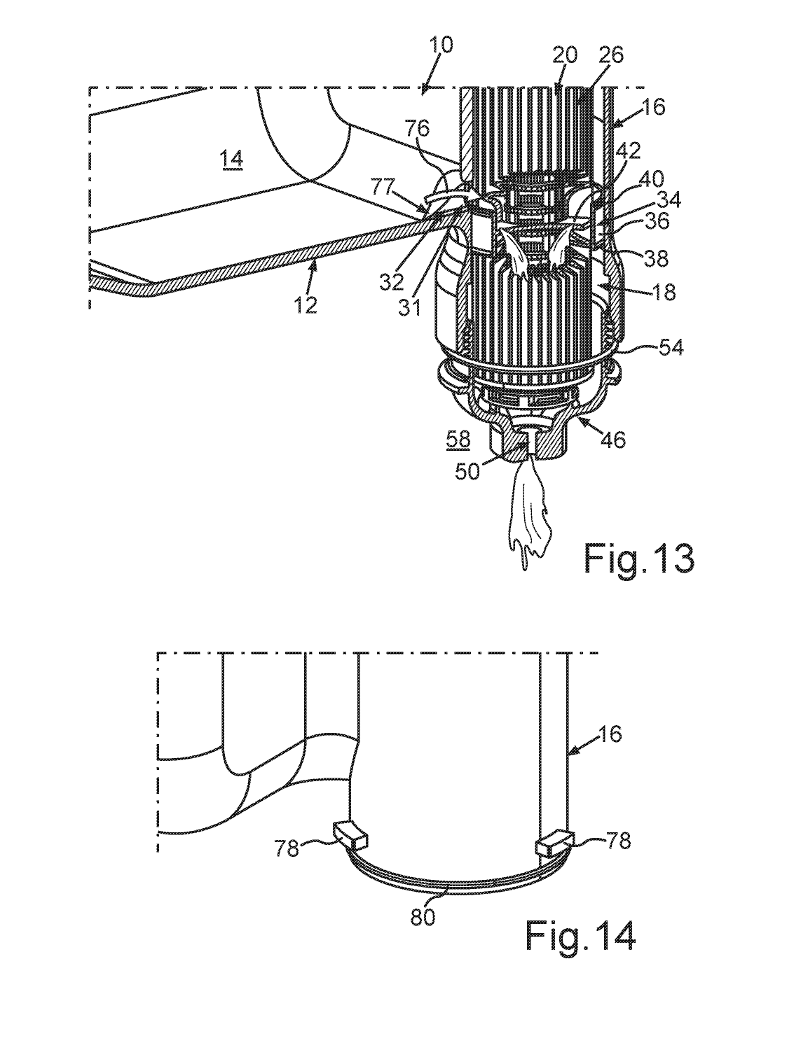

FIG. 10 furthermore shows that the filter housing cover 46 has a drain opening 56 which is formed as a passage opening and which is arranged at the geodetically lowest point of the cover 46 and opens at one end into the cover 46 and thus into the receiving region 18 and at the other end to an environment 58 outside the cover 46. An opening element in the form of a drain screw 60 is allocated to the drain opening 56. The drain opening 56 can be fluidically blocked (FIG. 10 shows the closed position) or unblocked (FIG. 13 shows the open position) by means of a corresponding actuation of the drain screw 60 which can be moved relative to the cover 46 and can be rotated in the present case. The drain screw 60 has a shaft 62 having an external thread 64, wherein an internal thread 66 corresponding to the external thread 64 is arranged in the drain opening 56. The drain screw 60 can be screwed to the cover 46 by means of the external thread 64 and the internal thread 66 and thus held on the cover 46.

The drain screw 60 also has a screw head 68, which is connected to the shaft 62, having tool engagement 70 formed as an external hexagon, wherein the tool engagement 70 can interact with positive locking with a corresponding tool, in particular a screwdriver. As a result of this positive-locking interaction, torques can be transferred from the tool to the drain screw 60 such that the drain screw 60 can be rotated relative to the cover 46 by means of the tool and can thereby be rotated between the closed position and the open position.

During an oil change, the existing lubricating oil is drained from the oil pan 12 during maintenance in order to be subsequently replaced with new lubricating oil. At the same time, the filter insert is removed from the filter housing 16 and replaced with a new filter element. In the present design of the lubricant supply device 10, the servicing process is supported by the design of the filter insert 20. As can be seen when viewing FIGS. 11, 12 and 13 together, the filter element 20 can be moved relative to the filter housing 16 between a position which closes the passage channel 32 and a position which opens the passage channel 32.

In order to drain the lubricating oil from the lubricant reservoir 14, i.e., from the oil pan 12, the filter insert is firstly moved from the blocking position into the open position, as can be seen in FIG. 11. For this purpose, the cover 46 is moved into a servicing position shown in FIG. 12 by the cover 46 being rotated relative to the filter housing 16, as illustrated by a directional arrow 72 in FIG. 11. In this case, the cover 46 is only partly unscrewed from the filter housing 16 without the cover 46 being completely detached from the filter housing 16. In other words, the filter housing cover 46 is still held on the filter housing 16 in the servicing position. The cover 46 is moved away from the support tube 24 into the service position by means of this unscrewing, such that the filter insert can be moved relative to the filter housing 16 in a translational manner, as illustrated by a directional arrow 74 in FIG. 11. Due to the fact that the cover 46 has been moved into the servicing position, the filter insert can slide partly downwards due to the force of gravity, and can thus move out of the blocking position into the open position. It is clear from FIG. 12 that the passage channel 32 is unblocked in the open position such that the lubricating oil received in the first receiving region 14 can flow through the passage channel 32, which forms a throughflow opening, and can flow into the receiving region 18, as illustrated by a directional arrow 76.

Overall, it is clear that the filter insert is supported on the cover 46 and is held in the receiving region 18 by means of the cover 46 and is held in particular in the blocking position. By moving the cover 46 into the servicing position, the filter insert sinks downwards in the vertical direction of the vehicle due to the force of gravity and thus moves from the blocking position into the open position.

In the state shown in FIG. 12, the lubricating oil cannot yet flow out of the lubricating oil supply device 10, in particular the filter housing 16, since the filter housing 16, in particular the mounting opening 48, is still closed by means of the cover 46 and the drain screw 60. In order to finally be able to drain the lubricating oil out of the filter housing 16, the drain screw 60 is moved from its closed position into its open position, as shown in FIG. 13, and is thus moved completely from the cover 46 and in particular out of the drain opening 56, for example. The lubricating oil can now flow from the lubricating oil reservoir 14 through the passage channel 32 into the second receiving region 18. From there, the lubricating oil flows through passage openings 44 to the geodetically lowest point of the cover 46 and thus to the drain opening 56 outwards towards the environment 58 where it can be collected.

In order to be able to drain the lubricating oil as completely as possible from the oil pan 12, the passage channel 32 opens into the lubricant reservoir 14 via an inlet opening 77, wherein the inlet opening 77, via which the lubricating oil can flow from the oil pan 12 into the passage channel 32 or the throughflow opening, is arranged at the geodetically lowest point of the oil pan 12.

The old oil draining off can be collected and disposed of. After complete drainage, the cover 46 can be completely detached and removed from the filter housing 16, after which the mounting opening 48 is unblocked. The used filter insert can then be moved out of the receiving region 18 and replaced with a new filter insert which can be moved, in particular inserted, into the second receiving region 18 via the mounting opening 48.

It is also possible to refill the lubricating oil supply device 10 with lubricating oil by means of a suitable draining device, in particular a corresponding valve, for example on the cover 46 or on the filter housing 16. For example, when the lid 46 is detached, the filter housing 16 and the oil pan 12 can be directly refilled with new lubricating oil. In this case, for example, the lubricating oil can be conveyed into the second receiving region 18 via the mounting opening 48, in particular by means of a pump, and into the first receiving region 14 via the passage channel 32.

It is furthermore conceivable to convey, in particular to feed, new lubricating oil via the drain opening 56 which is still open into the second receiving region 18 when the cover 46 is mounted on, in particular fastened to, the filter housing 16, and when the passage channel 32 is fluidically blocked by the sealing element 34. However, since the passage channel 32 is fluidically blocked by the sealing element 34, the lubricating oil supplied is pushed over the filter insert, i.e., through this and through the internal combustion engine such that all lubrication points of the internal combustion engine can be supplied, in particular flushed, with fresh oil before it starts.

FIG. 14 to 21 illustrate a further, third embodiment of the lubricating oil supply device 10. FIG. 14 shows the filter housing 16 in a schematic and perspective side view, wherein closure elements in the form of closure cams 78 are provided on the filter housing 16 of the third embodiment for the cover 46. In other words, the cover 46 can be fastened to the filter housing 16 by means of the closure cams 78. A sealing element in the form of a radial seal 80 is furthermore arranged on the filter housing 16 on the outer circumference, by means of which radial seal 80 the filter housing 16 can be sealed against the cover 46. For example, the radial seal 80 is formed as an O-ring. In the second embodiment, the cover 46 is at least partially screwed into the filter housing 16. In contrast, in the third embodiment, it is provided that the filter housing 16 is partially arranged in the cover 46, wherein the cover 46 is fastened reversibly detachably in the style of a bayonet closure on the filter housing 16.

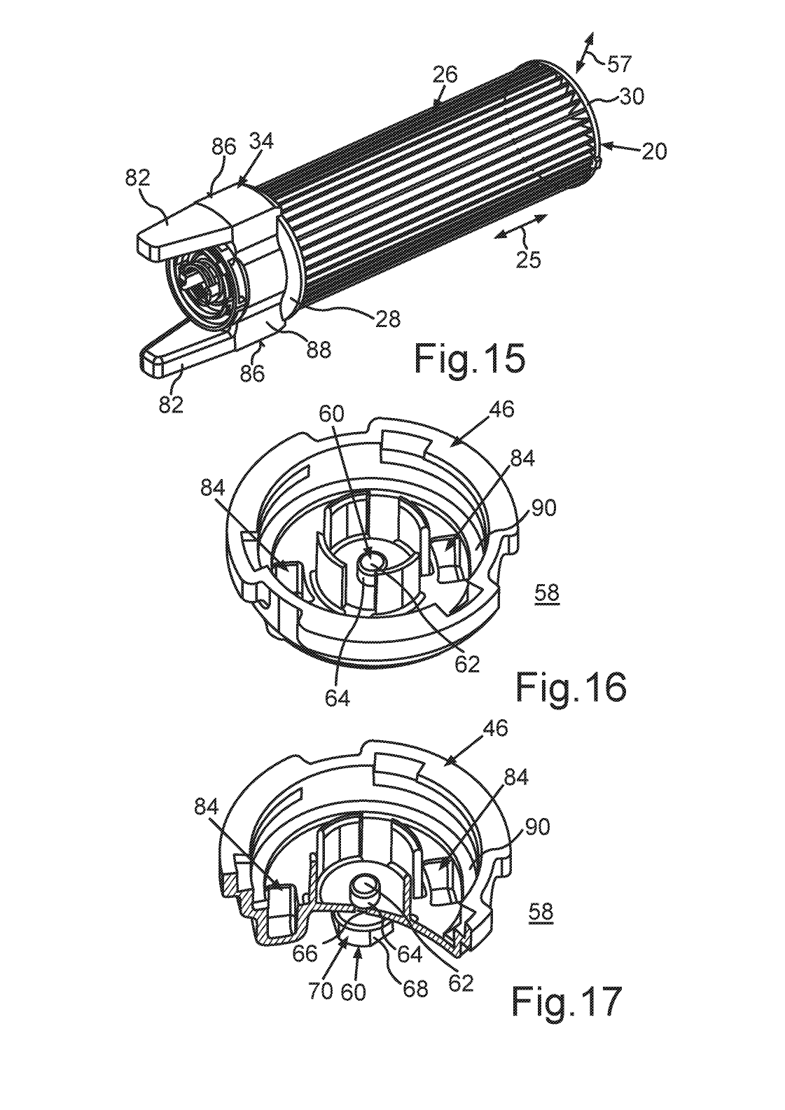

FIG. 15 shows the filter insert which belongs to the third embodiment. The filter insert has positive-locking elements in the form of pins 82 which correspond to positive-locking elements in the form of receptacles 84 provided on the cover 46. In the operational state of the lubricating oil supply device 10, the pins 82 are at least partially received in the corresponding receptacles 84 formed as hollow geometry such that the filter insert (filter element 20) interacts with positive locking with the cover 46 via the pins 82 and the receptacles 84. In other words, the filter insert is positively coupled to the cover 46 via the pins 82 and the receptacles 84 such that, when the cover 46 is rotated, torques are transferred to the filter insert. As a result, the filter insert can be moved via the cover 46 between the open position and the blocking position and in the present case can be rotated about an axis of rotation relative to the filter housing 16.

In the third embodiment, the sealing element 34 comprises respective sealing surfaces 86 which are arranged on opposite sides. The sealing surfaces 86 are, for example, injection moulded as two-component plastic elements on a base body 88 of the filter insert forming the pins 82.

FIGS. 16 and 17 show the cover 46 according to the third embodiment. A sealing element in the form of a flat seal 90 is arranged in the cover 46, by means of which flat seal 90 the cover 46 is sealed against the filter housing 16 in the axial direction. The radial seal 80 serves for radial sealing.

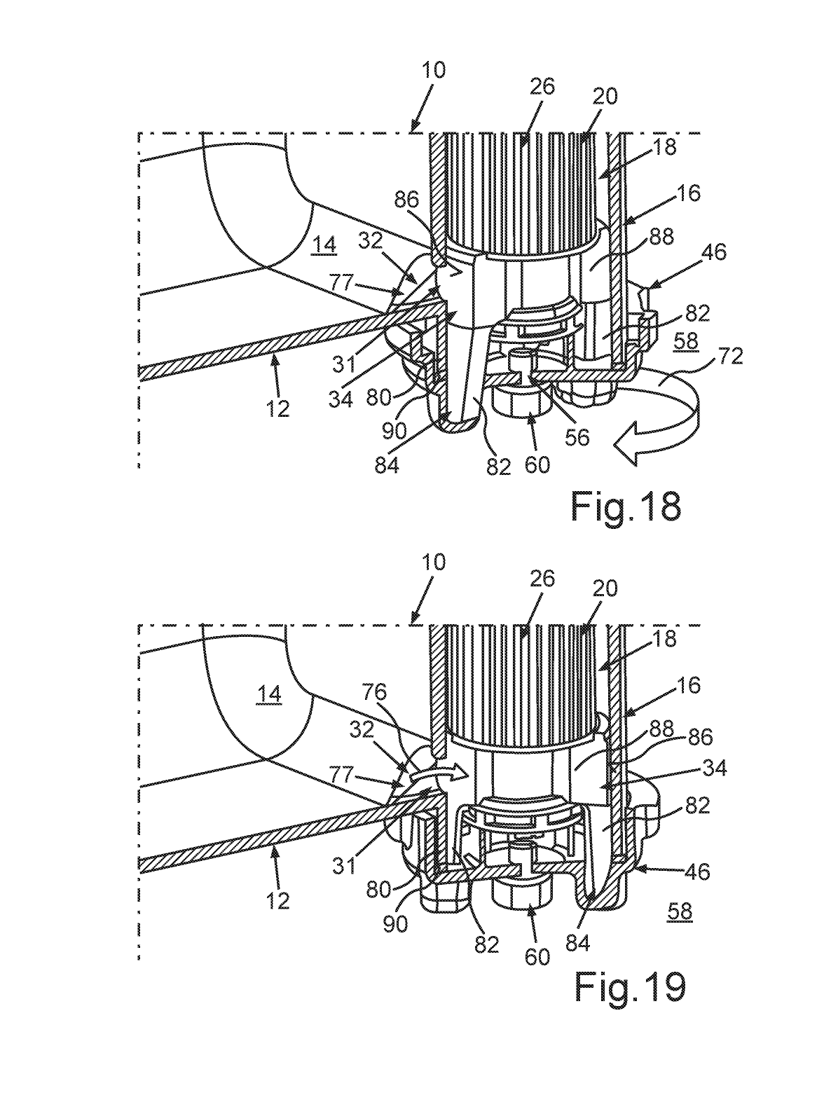

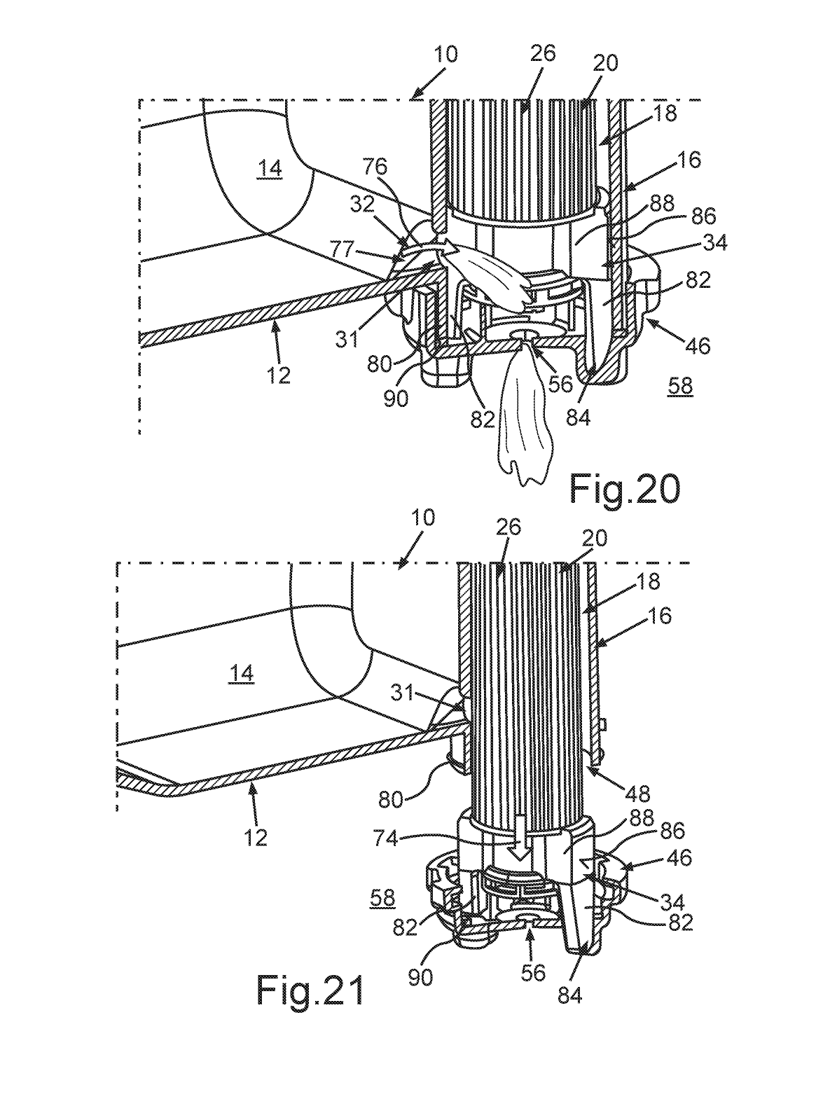

FIG. 18 shows the lubricating oil supply device 10, wherein the filter insert is initially still in the blocking position. It is particularly clear from FIG. 18 that the pins 82 are at least partially received in the corresponding receptacles 84 of the cover 46. In order to drain the lubricating oil from the oil pan 12 via the passage channel 32 into the filter housing 16, the cover 46 is firstly rotated into its servicing position, which is illustrated by the directional arrow 72 in FIG. 18. In this case, the cover 46 is rotated relative to the filter housing 16. As a result of the positive coupling of the cover 46 with the filter insert, this rotational movement of the cover 46 is transferred to the filter insert such that the filter insert is rotated via the cover 46 from the blocking position into the open position shown in FIG. 19 relative to the filter housing 16. In the blocking position shown in FIG. 18, the passage channel 32 is fluidically blocked by means of at least one of the sealing surfaces 86. In the open position, however, one sealing surface 86 unblocks the passage channel 32 so that the lubricating oil can flow from the oil pan 12 through the passage channel 32 and can flow into the filter housing 16. This is illustrated in FIG. 19 by the directional arrow 76. A flow of the lubricating oil from the filter housing 16 to the environment 58 is initially avoided since the drain opening 56 is initially still fluidically blocked by means of the drain screw 60. In order to finally drain the lubricating oil to the environment 58, the drain screw 60 is detached from the cover 46, as shown in FIG. 20, thereby fluidically unblocking the drain opening 56. The lubricating oil can then finally flow through the drain opening 56 and thus flow to the environment 58.

It can be seen from FIG. 21 that, after the lubricating oil has drained completely, the cover 46 is moved, in particular rotated, from the servicing position, in which the cover 46 is still held on the filter housing 16, into a dismounting position, in which the cover 46 is no longer held on the filter housing 16. The cover 46 can then be detached or removed from the filter housing 16. Since the cover 46 also serves to hold the filter insert in the second receiving region 18 in the second embodiment, the filter insert can be moved out of the second receiving region 18 in a translational manner when the cover 46 is detached from the filter housing 16. In other words, the filter insert is removed from the filter housing 16 together with the cover 46, after which the filter insert can be detached from the cover 46 by pulling the pins 82 out of the corresponding receptacles 84. Subsequently, the pins of another, new filter insert can be inserted into the receptacles 84 so that the cover 46 can then be reassembled together with the new filter insert on the filter housing 16.

1.-9. (canceled)

10. An apparatus for a filter device of an internal combustion engine, comprising:
a filter element for filtering a fluid of the internal combustion engine, wherein the filter element is insertable in a direction of an insertion axis along a lateral wall of a filter housing of the filter device;
wherein the filter element has a sealing element for fluidically blocking a throughflow opening formed in the lateral wall.

11. The apparatus according to claim 10, wherein the filter element has a support structure, wherein a filter material is disposed around the support structure, and wherein the sealing element projects radially from the support structure with a same or a greater spacing than the filter material.

12. The apparatus according to claim 11, wherein the sealing element surrounds at least a partial region of the filter material.

13. The apparatus according to claim 11, wherein the support structure is formed at a distance from the insertion axis and along a direction of longitudinal extension of the filter element which coincides with the direction of the insertion axis.

14. The apparatus according to claim 11, wherein the sealing element includes at least two sealing parts which are spaced apart from one another and are supportable on the lateral wall in order to block the throughflow opening.

15. The apparatus according to claim 14, wherein the at least two sealing parts are held on a sealing wall of the filter element which is impermeable for the fluid.

16. The apparatus according to claim 15, wherein the at least two sealing parts are softer than the sealing wall.

17. A filter device for an internal combustion engine, comprising:
a filter element; and
a filter housing, wherein the filter element is insertable along a lateral wall of the filter housing in a direction of an insertion axis;
wherein the filter element has a sealing element, wherein a throughflow opening formed in the lateral wall of the filter housing is fluidically blockable by the sealing element.

18. The filter device according to claim 17, wherein the filter element has a support structure, wherein a filter material is disposed around the support structure, and wherein the sealing element projects radially from the support structure with a same or a greater spacing than the filter material.

19. The filter device according to claim 18, wherein the sealing element surrounds at least a partial region of the filter material.

20. The filter device according to claim 18, wherein the support structure is formed at a distance from the insertion axis and along a direction of longitudinal extension of the filter element which coincides with the direction of the insertion axis.

21. The filter device according to claim 18, wherein the sealing element includes at least two sealing parts which are spaced apart from one another and are supportable on the lateral wall in order to block the throughflow opening.

22. The filter device according to claim 21, wherein the at least two sealing parts are held on a sealing wall of the filter element which is impermeable for the fluid.

23. The filter device according to claim 22, wherein the at least two sealing parts are softer than the sealing wall.
